(19) United States
(12) Patent Application Publication
(10) Pub. No.: US 2019/0302348 A1
(43) Pub. Date: Oct. 3, 2019

(54) REFLECTIVE DISPLAY DEVICE AND METHOD OF MANUFACTURING THE SAME

(71) Applicant: E Ink Holdings Inc., HSINCHU (TW)

(72) Inventors: Sheng-Chieh TAI, HSINCHU (TW); Chao-Chun CHENG, HSINCHU (TW)

(21) Appl. No.: 16/257,042

(22) Filed: Jan. 24, 2019

(30) Foreign Application Priority Data
Apr. 2, 2018 (TW) 107111675

(51) Int. Cl. F21V 8/00

(52) U.S. Cl. CPC G02B 6/0055; G02B 6/0036; G02B 6/0068; G02B 6/0073; G02B 6/0065

(57) ABSTRACT

A reflective display device includes at least one reflective display panel, a glass light guide plate, and a light source. The reflective display panel has a display surface. The glass light guide plate is over the display surface of the reflective display panel. The glass light guide plate has a top surface, a bottom surface, and a side surface between the top surface and the bottom surface. The top surface has a roughened surface, and the bottom surface is adjacent to the display surface of the reflective display panel. The light source is disposed on the side surface of the glass light guide plate.

### CROSS-REFERENCE TO RELATED APPLICATION

This application claims priority to Taiwan Application Serial Number 107111675, filed Apr. 2, 2018, which is herein incorporated by reference.

### BACKGROUND

### Field of Invention

The present invention relates to a reflective display device and the method of manufacturing the same.

### Description of Related Art

The reflective display device (such as electrophoretic display devices) has been widely used as display screens for electronic products in today's consumer electronics market. Since the reflective display devices do not emit light, it relies on external light source. Once the reflective display devices are located in an environment with weak external light, the reflective display panel cannot display images clearly. Therefore, the front-light module can be placed in front of the display surface of the reflective display panel to provide sufficient light to the reflective display panel since the external light source is insufficient, such that the reflective display panel can display the image.

Traditional reflective display device with front light module includes a display module and a front-light module disposed thereon. The front-light module includes a light guide plate, a light source disposed on a side surface of the light guide plate, optical clear adhesive (OCA), and protective layer, such as cover glass or anti-glare (AG) film. The light guide plate is disposed between the display module and the cover glass by using optical clear adhesive, and the light may be guided to the display module through the light guide plate. At present, the material of the light guide plate is predominantly plastic. However, the thermal expansion coefficient of the plastic material is greater than that of the glass, and therefore the thermal expansion of the light guide plate is greater than that of the glass in a high-temperature environment. As a result, bubbles are easily formed between the optical clear adhesive and the light guide plate, and it reduces the reliability of the reflective display device with the multi-layered plastic light guide plate. This issue becomes more serious when the plastic light guide plate is applied in large-sized reflective display devices.

### SUMMARY

In accordance with an aspect of the present invention, a reflective display device is provided. The reflective display device includes at least one reflective display panel, a glass light guide plate, and a light source. The reflective display panel has a display surface. The glass light guide plate is over the display surface of the reflective display panel, and has a top surface, a bottom surface, and a side surface between the top surface and the bottom surface. The top surface has a roughened surface, and the bottom surface is adjacent to the display surface of the reflective display panel. The light source is disposed on the side surface of the glass light guide plate.

According to some embodiments of the present invention, the roughened surface has a roughness of about 0.07-0.5 μm.

According to some embodiments of the present invention, the at least one reflective display panel includes a plurality of electrophoretic display modules, and each of the electrophoretic display modules is attached to the bottom surface of the glass light guide plate.

According to some embodiments of the present invention, the reflective display device further includes an adhesive layer between the display surface of the reflective display panel and the bottom surface of the glass light guide plate.

According to some embodiments of the present invention, the adhesive layer directly contacts the bottom surface of the glass light guide plate.

According to some embodiments of the present invention, the adhesive layer includes optical clear adhesive (OCA), or liquid optical clear adhesive (LOCA) resin, wherein the optical clear adhesive and liquid optical clear adhesive include polysiloxanes.

According to some embodiments of the present invention, the glass light guide plate has a transmittance of greater than or equal to about 80% in a wavelength range from about 380 to about 780 nm.

According to some embodiments of the present invention, the adhesive layer has a refractive index that is less than a refractive index of the glass light guide plate.

According to some embodiments of the present invention, the glass light guide plate includes soda-lime glass, low iron glass, or aluminosilicate glass.

According to some embodiments of the present invention, the glass light guide plate has a thickness of about 1-4 mm.

According to some embodiments of the present invention, the light source includes a plurality of light-emitting diodes (LEDs).

In accordance with another aspect of the present invention, a method of manufacturing a reflective display device is provided. The method includes performing a surface treatment to a top surface of a glass light guide plate to form a roughened surface on the top surface, and attaching a bottom surface of the glass light guide plate to the at least one reflective display panel with an adhesive layer.

According to some embodiments of the present invention, the surface treatment includes spraying an Anti-glare (AG) coating layer, spraying an etching solution, or etching a full surface of the glass light guide plate.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is cross-sectional view of a reflective display device in accordance with some embodiments of the present invention.

FIG. 2 is cross-sectional view of a reflective display device in accordance with some embodiments of the present invention.

FIG. 3 is a flow chart illustrating a method of manufacturing a reflective display device in accordance with some embodiments of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Furthermore, relative terms, such as “lower” or “bottom” and “upper” or “top”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

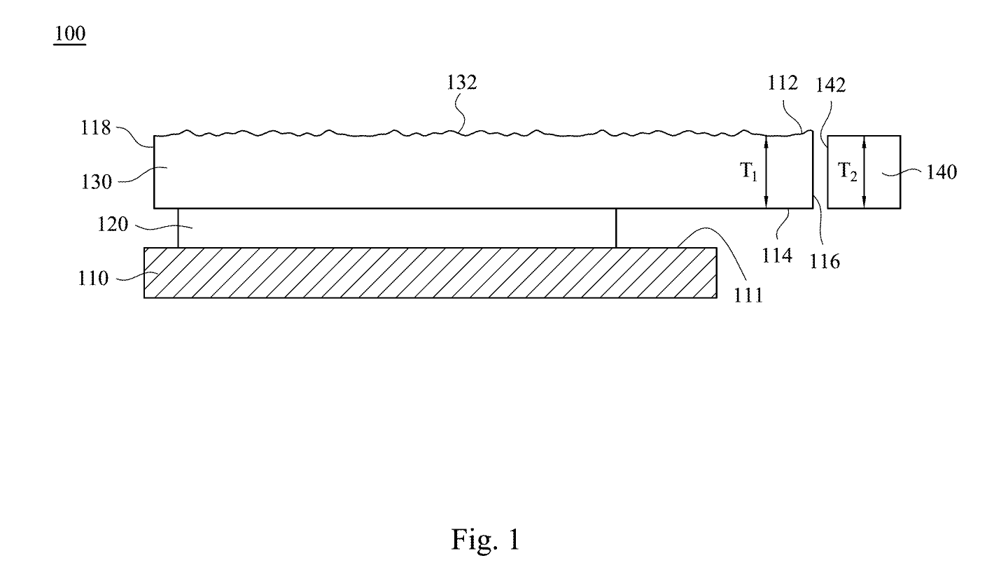

FIG. 1 is cross-sectional view of a reflective display device 100 in accordance with some embodiments of the present invention. The reflective display device 100 includes a reflective display panel 110, an adhesive layer 120, a glass light guide plate 130 and a light source 140.

The reflective display panel 110 has a display surface 111. According to some embodiments of the present invention, the reflective display panel 110 may include, but is not limited to, an electrophoretic display module. In some embodiments, the reflective display panel comprises a plurality of electrophoretic display modules, and each of the electrophoretic display modules is attached to the bottom surface of the glass light guide plate. The electrophoretic display module may be any suitable electrophoretic display module, and may include a front substrate, a display medium layer, an array substrate, a transparent electrode layer, a color filter layer, and a protective film (not shown in FIG. 1). The display medium layer may reflect the incident light, so that the user may observe the information or pattern displayed by the reflective display panel 110. In some examples, the display medium layer may include microcapsules or microcups.

The glass light guide plate 130 is over the display surface 111 of the reflective display panel 110. The glass light guide plate 130 has a top surface 112, a bottom surface 114, and side surfaces 116, 118 between the top surface 112 and the bottom surface 114. The bottom surface 114 is adjacent to the display surface 111 of the reflective display panel 110. According to various embodiments of the present invention, the top surface 112 of the glass light guide plate 130 has a roughened surface 132. In some embodiments, the entire top surface 112 may be the roughened surface 132. In other embodiments, a portion of the top surface 112 may be the roughened surface 132. The roughened surface 132 may break the total reflection of light transmitted in the glass light guide plate 130, and may guide the light to the reflective display panel 110. In some embodiments, the roughened surface 132 has a roughness (Ra) of about 0.07-0.5 μm. According to some embodiments, when the roughened surface 132 has the roughness in the range of about 0.07-0.5 μm, the reflective display device 100 may possess good light uniformity and brightness. If the roughened surface 132 has roughness greater than 0.5 μm, the reflective display device 100 may possess poor light uniformity, and results in a poor visual perception. In specifics, one side of the reflective display device 100 exhibits a bright image whereas another side thereof exhibits a dark image. For example, the end close to the light source 140 (i.e., the end close to the side surface 116) is brighter, and the end away from the light source 140 (i.e., the end close to the side surface 118) is darker. On the contrary, when the roughened surface 132 has a roughness of less than 0.07 μm, the light transmission efficiency is poor, such that the brightness of the reflective display device 100 may decrease. In some examples, the roughened surface 132 has roughness (Ra) of about 0.08, 0.1, 0.15, 0.2, 0.25, 0.3, 0.35, or 0.4 μm.

According to some embodiments of the present invention, the glass light guide plate 130 has a transmittance that is greater than or equal to about 80% at a wavelength in the range of about 380-780 nm. For example, the glass light guide plate 130 has a transmittance of about 80%, 85%, 90%, or 95% in the wavelength range of about 380-780 nm. In some embodiments, the glass light guide plate 130 has thickness T₁ of about 1-4 mm, such as 1.5 mm, 2 mm, 2.5 mm, 3 mm, or 3.5 mm. In some embodiments, material of the glass light guide plate 130 may include, but is not limited to, soda-lime glass, low iron glass, or aluminosilicate glass. The glass light guide plate 130 may be any suitable glass material, depending on the needed.

The glass light guide plate 130 has sufficient mechanical strength (e.g., better than plastic), and therefore the glass light guide plate 130 may be disposed on the outermost of the whole reflective display device 100 to protect the reflective display panel 110. The glass light guide plate 130 with the roughened surface 132 has all of the functions of light guiding, anti-glare, and protecting the reflective display device 100, and hence it can substitute the plastic light guide plate such as polymethylmethacrylate (PMMA), and the protective layer such as cover glass and anti-glare film, of the conventional reflective display device.

In some embodiments, the reflective display device 100 may further include an adhesive layer 120 between the display surface 111 of the reflective display panel 110 and the bottom surface 114 of the glass light guide plate 130. In other words, the glass light guide plate 130 may be disposed over the reflective display panel 110 and the adhesive layer 120. In some examples the adhesive layer 120 may cover the display surface 111, such that the reflective display panel 110 may be attached to the glass light guide plate 130.

According to some embodiments, the adhesive layer 120 may directly contact the bottom surface 114 of the glass light guide plate 130. In some embodiments, the adhesive layer 120 may be optical clear adhesive (OCA), liquid optical clear adhesive (LOCA), or the like. In some embodiments, the adhesive layer 120 may be OCA containing silicone or LOCA containing silicone. In other embodiments, the adhesive layer 120 may be OCA containing acrylate or LOCA containing acrylate. In some embodiments, the adhesive layer 120 may have a refractive index that is less than a refractive index of the glass light guide plate 130. In some embodiments, the adhesive layer 120 containing silicone has a refractive index of about 1.38-1.44, such as about 1.41. In some embodiments, the glass light guide plate 130 has a refractive index of about 1.48-1.55, about such as 1.51. Accordingly, the refractive index of the adhesive layer 120 is less than that of the glass light guide plate 130.

The light source 140 is adjacent to the side surface 116 of the glass light guide plate 130, and the light source 140 has a luminous surface 142 facing to the side surface 116 of the glass light guide plate 130. According to some embodiments, the light source 140 may include, but is not limited to, a plurality of light-emitting diodes (LEDs). In some embodiments, the light source 140 may be multiple light-emitting diodes in series, in parallel, or in parallel and series. In some embodiments, the luminous surface 142 of the light source 140 has a thickness T₂ that approximates to the thickness T₁ of the glass light guide plate 130, such that the reflective display panel 110 may obtain uniform illumination. In some embodiments, the thickness T₂ of the luminous surface 142 may be less than the thickness T₁ of the glass light guide plate 130. In other embodiments, the thickness T₂ of the luminous surface 142 may be equal to the thickness T₁ of the glass light guide plate 130. In yet other embodiments, the thickness T₂ of the luminous surface 142 may be greater than the thickness T₁ of the glass light guide plate 130. The light emitted from the luminous surface 142 of the light source 140 may entry the glass light guide plate 130 from the side surface 116, and the light may be transmitted in the glass light guide plate 130. The light may be uniformly scattered by the roughened surface 132 of the glass light guide plate 130, and emits to the reflective display panel 110. The light emitted to the reflective display panel 110 is then reflected through the glass light guide plate 130 to a viewer positioned out of the reflective display device 100.

It is understood that the relationship between elements and the material of the components described above will not be repeated hereinafter. In the following description, other reflective display device will be described.

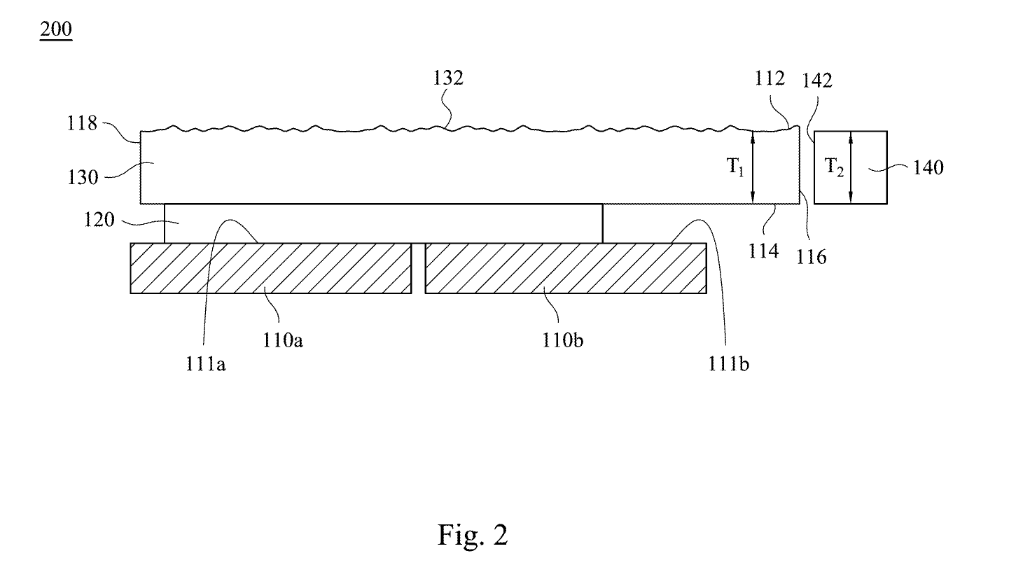

FIG. 2 is cross-sectional view of a reflective display device 200 in accordance with some embodiments of the present invention. The reflective display device 200 may include reflective display panels 110a, 110b, an adhesive layer 120, a glass light guide plate 130 and a light source 140. The difference between the reflective display device 200 and the reflective display device 100 is that the reflective display device 200 includes a spliced reflective display panel comprised of a plurality of reflective sub-panels, such as reflective display panels 110a and 110b. In some embodiments, the reflective display panels 110a and 110b may be electrophoretic display modules. The reflective display panel 110a and the reflective display panel 110b respectively have a display surface 111a and a display surface 111b, and both the display surfaces 111a, 111b are attached to the bottom surface 114 of the glass light guide plate 130. According to some embodiments, the reflective display device 200 may include at least one reflective display panel. Although FIG. 2 shows that the reflective display device 200 includes only two reflective display panel 110a, 110b spliced to each other, it should be understood that the number of the reflective display panel is not limited thereto. The number of the reflective display panel and the arrangement thereof may be selected depending on the needed, and the reflective display panels may be spliced seamlessly without gaps between the reflective display panels.

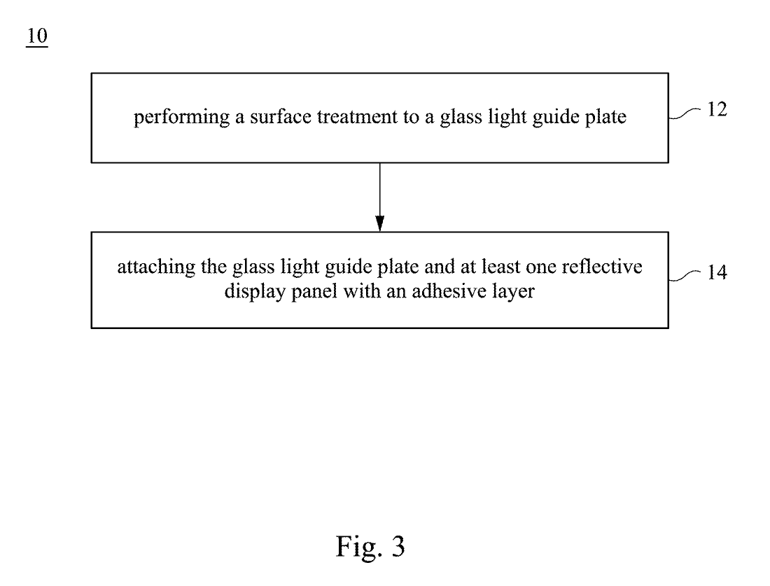

FIG. 3 is a flow chart illustrating a method 10 of manufacturing a reflective display device in accordance with various embodiments of the present invention. As shown in FIG. 3, the method 10 includes operation 12 and operation 14.

Reference is made to FIG. 1 and FIG. 3, at operation 12, performing a surface treatment to a glass light guide plate 130 to form a roughened surface 132 on the glass light guide plate 130. According to some embodiments of the present invention, the surface treatment may include, but is not limited to, spraying an anti-glare (AG) coating layer, spraying an etching solution, or full-surface etching of the glass light guide plate 130. In some embodiments, spraying the anti-glare (AG) coating layer may include spraying an anti-glare material to the top surface 112 of the glass light guide plate 130. In some embodiments, spraying the etching solution may include spraying etchant (such as HF) to the top surface 112 of the glass light guide plate 130. A suitable etching solution may be selected according to the material of the glass light guide plate 130, and the roughness of the top surface 112 may be controlled by adjusting the amount of the etching solution or the spraying time. In some embodiments, the full-surface etching of the glass light guide plate 130 may include soaking the glass light guide plate 130 in an etching solution, in which an opposite surface of the glass light guide plate 130 is protected from the etching solution. A suitable etching solution may be selected according to the material of the glass light guide plate 130, and the roughness of the top surface 112 may be controlled by the composition of the etching solution or by the soaking time.

The roughened surface 132 may destroy the total reflection of light transmitted in the glass light guide plate 130, and guide the light to the reflective display panel 110. In some embodiments, a physical strengthening process or a chemical strengthening process may be performed on the glass light guide plate 130 to strengthen the mechanical strength of the glass light guide plate 130. The glass light guide plate 130 undergone the surface treatment may have the function of light guiding, anti-glare, and protecting the reflective display device 100, and hence the glass light guide plate 130 can substitute the plastic light guide plate such as polymethylmethacrylate (PMMA), and the protective layer such as cover glass and anti-glare film, used in the conventional reflective display device.

Reference is made to FIGS. 1-3, the method 10 continues with operation 14 by attaching the glass light guide plate 130 to the at least one reflective display panel 110 with an adhesive layer 120. According to some embodiments of the present invention, as shown in FIG. 1, the bottom surface 114 of the glass light guide plate 130 is attached to the display surface 111 of the reflective display panel 110 by the adhesive layer 120. According to other embodiments, as shown in FIG. 2, the bottom surface 114 of the glass light guide plate 130 is attached to the display surfaces 111a, 111b of the well-arranged reflective display panels 110a, 110b by the adhesive layer 120. In some embodiments, the adhesive layer 120 may be optical clear adhesive (OCA), liquid optical clear adhesive (LOCA), or the like. In some embodiments, the display surface 111 of the reflective display panel 110 may be attached to the bottom surface 114 of the glass light guide plate 130 by a solid optical clear adhesive (OCA), or a liquid optical clear adhesive (LOCA) through a curing process.

As described above, according to the embodiments of the present invention, performing the surface treatment to the glass light guide plate forms a roughened surface on the top surface of the glass light guide plate. The roughened surface may destroy the total reflection of light transmitted in the glass light guide plate, such that the reflective display panel obtains uniform illumination. The glass light guide plate with the roughened surface may guide the light and protect the reflective display device, and therefore can substitute the light guide plate, anti-glare layer and the cover glass used in the conventional reflective display device. By using the glass light guide plate with the roughened top surface, the total number of times of attaching components may be reduced during the fabrication of the reflective display device. The glass light guide plate has less thermal deformation than the commonly used plastic light guide plate. Moreover, replacing the plastic light guide plate with the glass light guide plate may avoid the yellowing problem caused by sunlight. Therefore, the reflective display device equipped with the glass light guide plate disclosed herein may further have good reliability at a high-temperature and in high humidity environment.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A reflective display device, comprising:
a reflective display panel, wherein the reflective display panel has a display surface;
a glass light guide plate over the display surface of the reflective display panel, wherein the glass light guide plate has a top surface, a bottom surface, and a side surface between the top surface and the bottom surface, the top surface has a roughened surface, and the bottom surface is adjacent to the display surface of the reflective display panel; and
a light source disposed on the side surface of the glass light guide plate.

2. The reflective display device of claim 1, wherein the roughened surface has a roughness of about 0.07-0.5 μm.

3. The reflective display device of claim 1, wherein the reflective display panel comprises a plurality of electrophoretic display modules, and each of the electrophoretic display modules is attached to the bottom surface of the glass light guide plate.

4. The reflective display device of claim 1, further comprising an adhesive layer between the display surface of the reflective display panel and the bottom surface of the glass light guide plate.

5. The reflective display device of claim 4, wherein the adhesive layer directly contacts the bottom surface of the glass light guide plate.

6. The reflective display device of claim 4, wherein the adhesive layer comprises optical clear adhesive (OCA), or liquid optical clear adhesive (LOCA) resin, wherein the optical clear adhesive and the liquid optical clear adhesive comprise polysiloxanes.

7. The reflective display device of claim 6, wherein the glass light guide plate has a transmittance of greater than or equal to about 80% in a wavelength range from about 380 to about 780 nm.

8. The reflective display device of claim 4, wherein the adhesive layer has a refractive index that is less than a refractive index of the glass light guide plate.

9. The reflective display device of claim 1, wherein the glass light guide plate comprises soda-lime glass, low iron glass, or aluminosilicate glass.

10. The reflective display device of claim 1, wherein the glass light guide plate has a thickness of about 1-4 mm.

11. The reflective display device of claim 1, wherein the light source comprises a plurality of light-emitting diodes (LEDs).

12. A method of manufacturing a reflective display device, comprising:
performing a surface treatment to a top surface of a glass light guide plate to form a roughened surface on the top surface; and
attaching a bottom surface of the glass light guide plate to the reflective display panel with an adhesive layer.

13. The method of claim 12, wherein the surface treatment comprises spraying an Anti-glare (AG) coating layer, spraying an etching solution, or etching a full surface of the glass light guide plate.
